(19) United States
(12) Patent Application Publication
(10) Pub. No.: US 2018/0003359 A1
(43) Pub. Date: Jan. 4, 2018

(54) THREE DIMENSIONAL GLASS STRUCTURE, DECORATED MOLDING ARTICLE AND METHOD FOR FABRICATING DECORATED MOLDING ARTICLE

(71) Applicant: Jin Ya Dian Technology Co.,Ltd., Taoyuan City (TW)

(72) Inventors: Kuo-Liang Ying, Taoyuan City (TW); Ya-Yu Lai, New Taipei City (TW)

(73) Assignee: Jin Ya Dian Technology Co.,Ltd., Taoyuan City (TW)

(21) Appl. No.: 15/246,571

(22) Filed: Aug. 25, 2016

(30) Foreign Application Priority Data
Jun. 29, 2016 (TW) 105120441

(51) Int. Cl. F21S 8/10; B32B 7/12; B32B 17/06; F21V 3/02; F21V 25/12; C03C 17/34; C03C 27/02; F21W 121/00; F21Y 2115/10

(52) U.S. Cl. CPC F21S 48/30; C03C 17/34; B32B 7/12; B32B 17/061; C03C 27/02; F21V 3/02; F21V 25/12; F21Y 2115/10; B32B 2255/28; C03C 2217/72; B32B 2307/412; B32B 2605/08; F21W 2121/00

(57) ABSTRACT

A three dimensional (3D) glass structure for decorating a workpiece includes a 3D glass layer, a light emitting layer, and a decorating layer. The 3D glass layer has a front surface and a back surface opposite to each other. The light emitting layer is disposed on the back surface of the 3D glass layer. The decorating layer is disposed between the 3D glass layer and the light emitting layer.

### CROSS-REFERENCE TO RELATED APPLICATION

This application claims the priority benefit of Taiwan application serial no. 105120441, filed on Jun. 29, 2016. The entirety of the above-mentioned patent application is hereby incorporated by reference herein and made a part of this specification.

### BACKGROUND OF THE INVENTION

### 1. Field of the Invention

The present invention generally relates to a glass structure, decorated molding article and fabrication method thereof, in particular, to a three dimensional (3D) glass structure, decorated molding article and fabrication method thereof.

### 2. Description of Related Art

As currently known, the interior and exterior decoration method for car mainly uses the spraying process or the printing process to form decoration pattern or text on the surface of object, so as to express the particular visual effect and thereby increase the variability of the object appearance. However, the spraying process is not suitable for mass production because it has the disadvantages of consuming time, complicate processing and poor of thickness uniformity, and so on. To solve the foregoing issues, several specific decoration processes by using 3D glass structure have been proposed. For example, the in-mold decoration (IMD) technology or the out mold decoration (OMD) technology has been another choice for forming pattern or text on the surface of object.

In better detail, the IMD technology mainly disposes a transfer film printed with pattern into a mold, such as injection molding machine, and then the resin is injected into the mold so to let the resin be combined with the transfer film. After the resin is cooled down, the decorated molding article is taken out from the mold, and the IMP process accomplishes. Further, the OMD technology takes the high pressure vacuum transfer manner, so to directly cover the transparent 3D glass structure or pattern layer, on which pattern or text is printed, onto the outer surface of workpiece. The decorated molding article formed by the OMD technology has the property of covering a bent portion, which can be widely used to decorate on various housing materials and can further increase the decoration application on product's appearance.

### SUMMARY OF THE INVENTION

The present invention provides a 3D glass structure, a decorated molding article and a fabrication method thereof, which can decorate a 3D glass structure onto a workpiece by IMD technology or OMD technology. Fabrication process can be simplified and cost can be reduced.

In an embodiment, the invention provides a 3D glass structure, a decorated molding article and a fabrication method thereof, which can be applied to workpieces for interior decoration of car, exterior decoration of car, logo of car, car dashboard, and so on. As a result, appearance of the workpiece can have streamlined appearance and 3D dimensional texture, and further provide a better 3D tactile texture to the user.

The invention provides a 3D glass structure for decorating a workpiece, which includes a 3D glass layer, a light emitting layer, and a decorating layer. The 3D glass layer has a front surface and a back surface opposite to each other. The light emitting layer is disposed on the back surface of the 3D glass layer. The decorating layer is disposed between the 3D glass layer and the light emitting layer.

In an embodiment of the invention, the foregoing front surface of the 3D glass layer includes matte finish surface, mirror surface, uneven surface, or a combination thereof.

In an embodiment of the invention, the foregoing 3D glass layer includes a curving-surface glass, a flat-surface glass, or a combination thereof.

In an embodiment of the invention, the foregoing decorating layer includes a single layer structure or a multi-layer structure.

In an embodiment of the invention, the foregoing decorating layer includes a base layer, a pattern layer, and a hard coating layer. The pattern layer is disposed on the base layer. The hard coating layer is disposed between the base layer and the pattern layer.

In an embodiment of the invention, the foregoing decorating layer further includes a first adhesive layer disposed on the pattern layer. The decorating layer is adhered to the back surface of the 3D glass layer by the first adhesive layer.

In an embodiment of the invention, the foregoing hard coating layer has a first surface and a second surface opposite to each other. The first surface is a flat surface and the second surface is an uneven surface.

In an embodiment of the invention, the foregoing hard coating layer contacts with the base layer via the first surface, and contacts with the pattern layer via the second surface.

In an embodiment of the invention, the foregoing light emitting layer includes a backlight module of light emitting diode, a backlight module of conductive polymer, or a combination thereof.

In an embodiment, the invention provides a decorated molding article, including a workpiece and a 3D glass structure. The workpiece has an outer surface. The 3D glass structure is disposed on the outer surface of the workpiece. The 3D glass structure is adhered to the workpiece via a second adhesive layer.

In an embodiment of the invention, a material of the outer surface of the foregoing workpiece includes plastic, metal, carbon fiber, glass, or a combination thereof.

In an embodiment of the invention, the workpiece includes a housing or an assembly part of an electronic apparatus, a housing or an assembly part of vehicle or a combination thereof. The housing or the assembly part of vehicle includes interior decoration of car, exterior decoration of car, car logo, car dashboard, intelligent key (I-key), engine start button, or a combination thereof.

In an embodiment, the invention provides a fabrication method for a decorated molding article including the following steps. A 3D glass structure is provided. The 3D glass structure is processed by an IMD process or an OMD process, so that the 3D glass structure is adhered to an outer surface of a workpiece via a second adhesive layer.

In an embodiment of the invention, the foregoing 3D glass structure is processed by the IMD process by the following steps. The 3D glass structure is disposed in an IMD mold having a molding cavity. The 3D glass structure covers at least a portion of a surface of the molding cavity. The molding material is injected into IMD mold, so that the molding material and the 3D glass structure are combined to each other. The molding material is cooled down. The decorated molding article is taken out from the IMD mold.

In an embodiment of the invention, the foregoing 3D glass structure is processed by the OMD process by the following steps. A workpiece is provided. The workpiece and the 3D glass structure are disposed in a mold. A high pressure decorative molding process is performed, so to adhere the 3D glass structure onto an outer surface of the workpiece via a second adhesive layer.

In an embodiment of the invention, the high pressure decorative molding process is following. A heating and softening step is performed on the 3D glass structure. The 3D glass structure contacts with the workpiece and a step of pressing is performed. A high pressure vacuum molding step is performed on the 3D glass structure and the workpiece, so that the 3D glass structure adheres onto an outer surface of the workpiece.

In an embodiment of the invention, the process for forming the 3D glass structure includes the steps as follows. A 3D glass layer is provided. The 3D glass layer has a front surface and back surface opposite to each other. A light emitting layer is formed on the back surface of the 3D glass layer. A decorating layer is formed between the 3D glass layer and the light emitting layer.

In an embodiment of the invention, the process to form the decorating layer between the 3D glass layer and the light emitting layer is as follows. A base layer is provided. A pattern layer is formed on the base layer. A hard coating layer is formed between the base layer and the pattern layer. A first adhesive layer is formed on the pattern layer.

In an embodiment of the invention, the method to form the decorating layer between the 3D glass layer and the light emitting layer includes performing transfer molding process. The step of transfer molding process is as follows. A heating process is performed on the decorating layer. The first adhesive layer of the decorating layer contacts with the back surface of the 3D glass layer and a step of pressing is performed so that the decorating layer is adhered to the back surface of the 3D glass layer via the first adhesive layer.

In an embodiment of the invention, the method for forming the decorating layer includes directly forming the decorating layer on the back surface of the 3D glass layer by using printing, spray coating, electrical plating, vapor deposition, sputtering deposition, or a combination thereof.

As to the foregoing descriptions, the invention uses IMD technology or OMD technology to decorate the workpiece with the 3D glass layer, so that the appearance of the workpiece has a streamlined appearance and dimensional texture and thereby provides a better quality of touch on the dimensional texture to the user. In addition, comparing with the conventional decorating piece, the 3D glass structure of the invention further has the capabilities of expanding effect, no frame design, lighting design and pattern highlight. As a result, the 3D glass structure of the invention can provide the user with a decorating quality different from the conventional decorating piece. Further in the invention, the decorating layer is adhered to the back surface of the 3D glass layer, so to form the 3D glass structure. As a result, the 3D glass structure not only has the decorating effect but also has explosion-proof features.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing, illustrating a cross-sectional structure of the 3D glass structure, according to a first embodiment of the invention.

FIG. 2 is a schematic drawing, illustrating a cross-sectional structure of the 3D glass structure, according to a second embodiment of the invention.

FIG. 3 is a schematic drawing, illustrating a cross-sectional structure of the decorated molding article, according to a third embodiment of the invention.

FIG. 4 is a schematic drawing, illustrating a cross-sectional structure of the decorated molding article, according to a fourth embodiment of the invention.

FIG. 5 is a flow-chart drawing, illustrating a fabricating flow of the 3D glass structure in the first embodiment of the invention.

FIG. 6 is a flow-chart drawing, illustrating a fabricating flow of the 3D glass structure in the second embodiment of the invention.

FIG. 7 is a flow-chart drawing, illustrating a fabricating flow of the decorated molding article, according to a fifth embodiment of the invention.

FIG. 8 is a flow-chart drawing, illustrating a fabricating flow of the decorated molding article, according to a sixth embodiment of the invention.

### DESCRIPTION OF THE EMBODIMENTS

Reference will now be made in detail to the present preferred embodiments of the invention, examples of which are illustrated in the accompanying drawings. However, the invention can be configured by various forms and is not limited to the embodiments. The terms about pointing direction as used in the embodiments, such as “up”, “down” et al. are additionally added in drawing just for reference. So, the terms about pointing direction are used for descriptions and not for limiting the invention. The same or similar reference number is also representing the same or similar element. The following descriptions will not repeat the statements above.

First, it is described that the 3D glass structure 100 of the first embodiment and the 3D glass structure 200 of the second embodiment in the invention can be used to decorate the workpiece, so the outer appearance of the workpiece in design can have streamlined appearance and 3D dimensional texture, and further provide a better 3D tactile texture to the user.

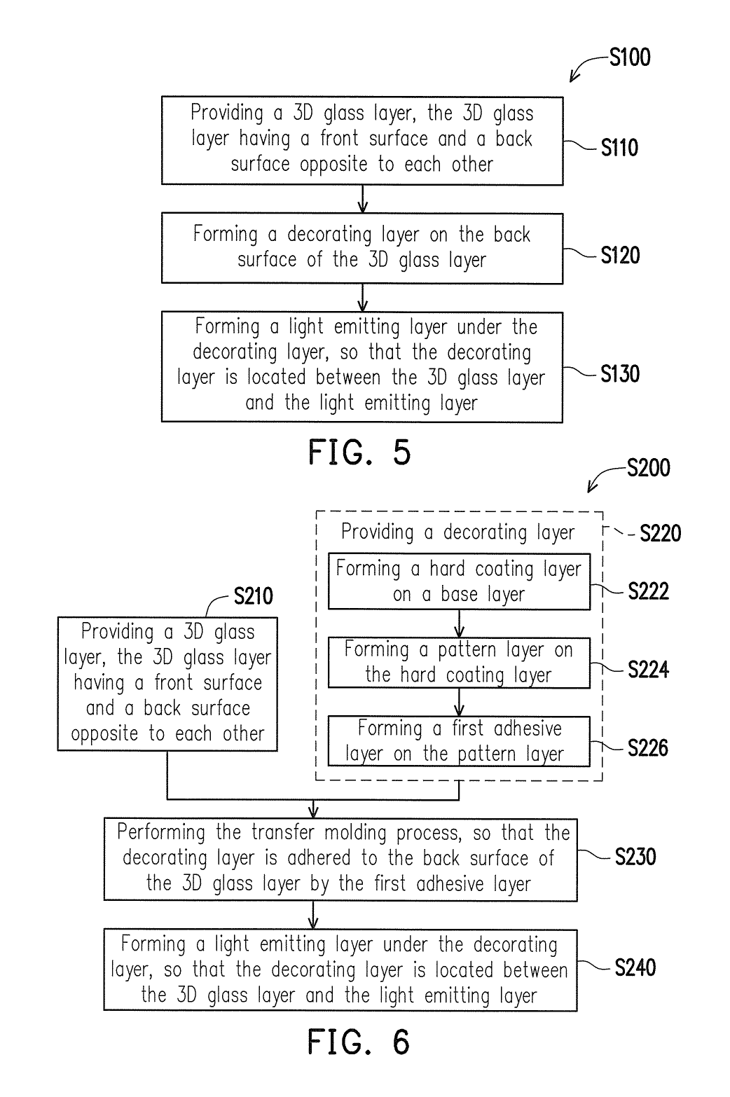

FIG. 1 is a schematic drawing, illustrating a cross-sectional structure of the 3D glass structure, according to a first embodiment of the invention. FIG. 5 is a flow-chat drawing, illustrating a fabricating flow of the 3D glass structure in the first embodiment of the invention.

Referring to FIG. 1 and FIG. 5, the fabrication process S100 for the 3D glass structure 100 of the first embodiment is following. The step S110 is performed to provide a 3D glass layer 102. The 3D glass layer 102 has a front surface 102a and a back surface 102b, opposite to each other. In the first embodiment, the 3D glass layer 102 in an example can be curving-surface glass, flat-surface glass, or a combination thereof. In an example, when the 3D glass layer 102 is a curving-surface glass, its appearance has streamlined appearance and 3D dimensional texture. Relative to the flat-surface glass, the curving-surface glass can provide a better 3D tactile texture to the user. In addition, the curving-surface glass is a design without frame, so that the curving-surface glass to the visual effect can have expanding effect. Further, although the front surface 102a illustrated in FIG. 1 is located over the back surface 102b. However, the invention is not limited to this. In other embodiments, the front surface 102a can be located under the back surface 102b.

In some embodiments, the front surface 102a of the 3D glass layer 102 can be performed by a working process of sputtering, coating, immersing or other proper method, so that the front surface 102a of the 3D glass layer 102 becomes a matte finish surface, mirror surface, uneven surface, or a combination thereof. The working process includes decoration working process, functionality working process, or a combination thereof. As a result, the 3D glass layer 102 of the embodiment can have functions of stain resistance, scratch resistance, high hardness and so on, but also have the function of smooth touch. In alternative embodiments, the front surface 102a of the 3D glass layer 102 forms one layer or more layers for matte finish layer or stain-resistance layer, so that the functionality and different visual effects can be increased.

Then, the step S120 is performed, in which the back surface 102b of the 3D glass layer 120 is formed with a decorating layer 104. In detail, the decorating layer 104 can be directly formed on the back surface 102b of the 3D glass layer 120 by printing, spray coating, electrical plating, vapor deposition, sputtering deposition, or a combination thereof, so to achieve the different visual effects. As an example, the decorating layer 104 can be composed from the printing ink or printable material, such as single ink layer, multiple ink layers or a multi-layered patterned ink layer, so as to respectively show a monochromatic, polychromatic or desired pattern. The decorating layer 104 can increase the pattern and color diversity of the 3D glass structure 100 and enrich the visual effects to the user or viewer's. In an embodiment, the decorating layer 103 can have a proper material, such as polyurethane (PU), polyacrylate, polyethylene terephthalate (PET), ethylene, propylene, polyolefin (PO), or Polymethylmethacrylate (PMMA).

Then, the step S130 is performed, in which a light emitting layer is formed under the decorating layer 104, so that the decorating layer 104 is located between the 3D glass layer 102 and the light emitting layer 106. In detail, when the light emitted form the light emitting layer 106 enters the field of vision of user or viewer through the decorating layer 104 and the 3D glass layer 102, the different visual effects can be produced and different textures of decorative effects can be further provided. In an embodiment, the light emitting layer 106 in an example can be light emitting diode (LED) backlight module, conductive polymer backlight module, other proper backlight module, or a combination thereof.

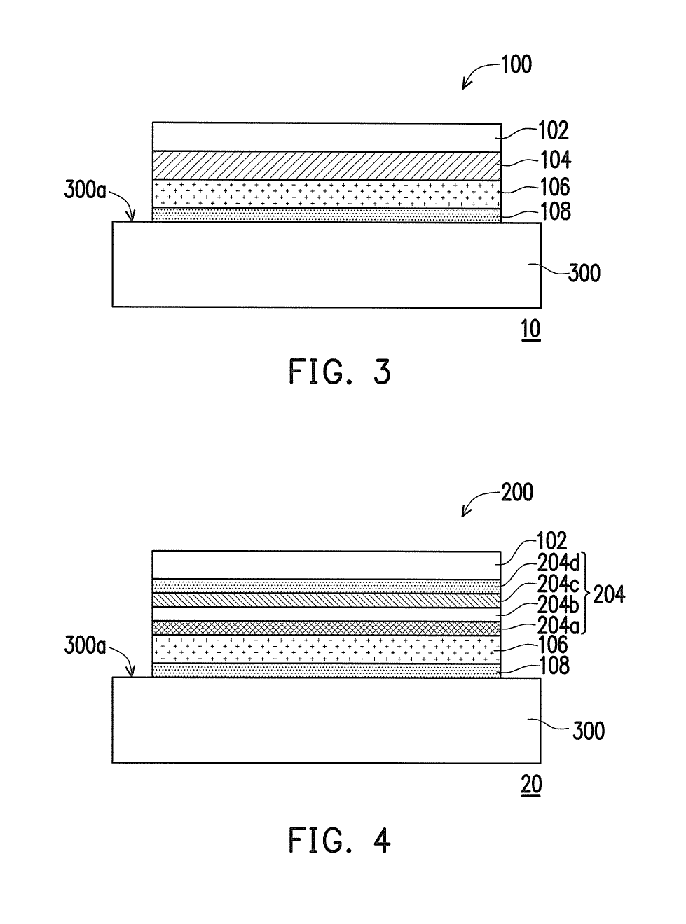

As to foregoing descriptions, the 3D glass structure 100, as fabricated by the fabrication method of 3D glass structure 100 in foregoing first embodiment, includes the 3D glass layer 102, the light emitting layer 106, and the decorating layer 104. The 3D glass layer 102 has a front surface 102a and a back surface 102b, opposite to each other. The light emitting layer 106 is located on the back surface 102b of the 3D glass layer 102. The decorating layer 104 is located between the 3D glass layer 102 and the light emitting layer 106. In addition, the 3D glass structure 100 can further include a second adhesive layer 108, as shown in FIG. 3, under the light emitting layer 106, so that the 3D glass structure 100 through the second adhesive layer 108 can be adhered to a portion of the outer surface 300a of the workpiece 300, as shown in FIG. 3.

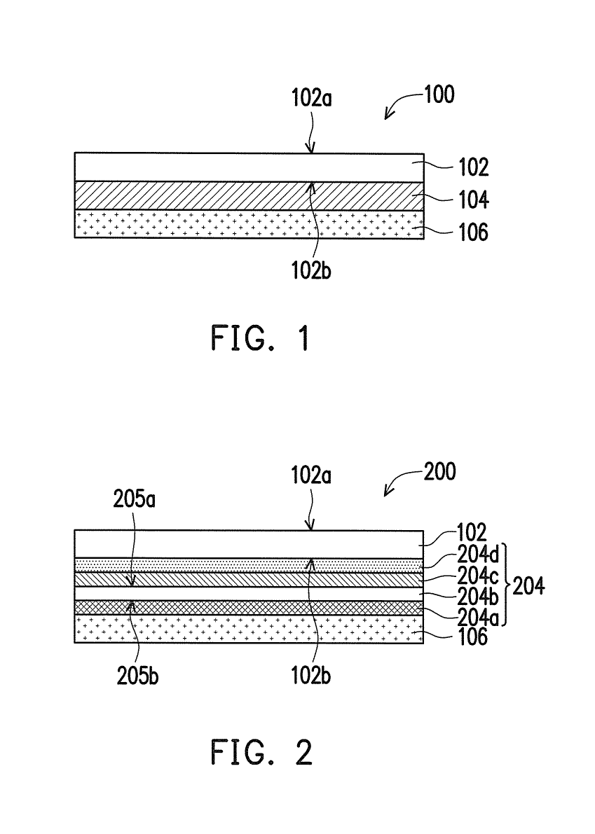

FIG. 2 is a schematic drawing, illustrating a cross-sectional structure of the 3D glass structure, according to a second embodiment of the invention. FIG. 6 is a flow-chat drawing, illustrating a fabricating flow of the 3D glass structure in the second embodiment of the invention.

Referring to FIG. 1, FIG. 2, FIG. 5 and FIG. 6, the fabrication process S200 for the 3D glass structure 200 of the second embodiment is basically similar to the fabrication process S100 for the 3D glass structure 100 of the first embodiment, that is, the step S110 and the step S210 are similar. The step S210 like the step S110 has been described in foregoing descriptions and is not repeated in description. The difference between the two steps is that the decorating layer 204 in the second embodiment is multi-layer structure and the decorating layer 104 in the first embodiment is a single-layer structure. In other words, the step S220, that is, providing the decorating layer 204 in the second embodiment for the 3D glass structure 200 can further include the step S222, the step S224 and the step S226.

In detail, a base layer 204a is provided. In an embodiment, the base layer 204a in an example can be a proper material, such as polyethylene terephthalate (PET), ethylene, propylene, polyolefin (PO) or polymethylmethacrylate (PMMA). The step S222 is performed to form a hard coating layer 204b on the base layer 204a. In detail, a resin-material layer (not shown) is formed on the base layer 204a by roller a coating method, a spray coating method, a printing method or a coating method. Then, the resin-material layer is illuminated by UV light or heated, so to be cured or harden to form the hard coating layer 204b. In an embodiment, material of the resin-material layer in an example can be an ultraviolet curable resin or a thermosetting resin. Taking an example, the material of the resin-material layer can be acrylic resin, polyurethane (PU), epoxy resin, or a combination thereof. The hard coating layer 204b as formed by the above manners includes a first surface 205a and a second surface 205b opposite to each other. In some embodiments, the first surface 205a is an uneven surface and the second surface 205b is a flat surface. The hard coating layer 204b contacts with the base layer 204a by the second surface 205b and contacts with a pattern layer 204s, which is subsequently formed, by the first surface 205a. However, the invention is not limited to this. In alternative embodiment, the first surface 205a and the second surface 205b of the hard coating layer 204b can both be flat surfaces or uneven surfaces.

Then, the step S224 is performed, in which the pattern layer 204c is formed on the hard coating layer 204b, so that the hard coating layer 204b is located between the base layer 204a and the pattern layer 204c. In detail, the pattern layer 204c can be formed by transferring ink on the hard coating layer 204b by a proper process, such as printing process (e.g. gravure printing), screen printing process, flexographic printing process, offset printing process, reverse printing, or ink-jet printing process. The pattern layer 204c can increase the pattern and color diversity of the 3D glass structure 200, so to enrich the visual effects to the user or viewer's. In an embodiment, material of the pattern layer 204c in an example can be mixed with an inorganic material, such as polyurethane or polyacrylate. In some embodiments, when the first surface 205a of the hard coating layer 204b is uneven surface, the pattern layer 204c as formed can fully cover the uneven surface 205a of the hard coating layer 204b, so at improve the flatness of the first surface 205a. Thereby, the pattern layer 204c can enrich the visual effects to the user or viewer's but also increase the adhesive capability of the first adhesive later 204d as subsequently formed.

Then, the step S226 is performed, in which the first adhesive layer 204d is formed on the pattern layer 204c to form the decorating layer 204 in multi-layer structure. In an embodiment, the first adhesive layer 204d can be hot-melt adhesives, UV-curing adhesive, light-curing adhesive, electron-curing adhesive or a combination thereof. Taking an example, material of the first adhesive layer 204d can at least one freely selected from polyacrylate, polymethacrylate, polystyrene, polycarbonate, polyurethane, polyester, polyamide, epoxy resin, ethylene vinylacetate copolymer (EVA), or thermoplastic elastomer, or a copolymer, a mixer, or a composite from the above materials.

Further to remark, the sequence of the step S210 and the step S220 can be adjusted according to the actual need. In other words, although the foregoing descriptions first provide the 3D glass layer 102 (that is step S210) and then provide the decorating layer 204 (that is step S220), the invention is not limited to this. In other embodiment, the step S220 can be performed first, after then the step S210 is performed.

In continuation, the step S230 is performed, in which the transfer molding process is performed, so that the decorating layer 204 through the first adhesive layer 204d is adhered to the back surface 102b of the 3D glass layer 102. In detail, the transfer molding process in an example firstly performs a heating step on the decorating layer 204, so as to soften the decorating layer 204. In an embodiment, the temperature of the heating step can be in a range from 80° C. to 150° C. The duration for the heating step can be in a range from 30 seconds to 180 seconds. Then, the first adhesive layer 204d of the decorating layer 204 contacts with the back surface 204b of the 3D glass layer 102 and a pressing step is performed. As a result, the decorating layer 204 through the first adhesive layer 204d is transferred to the back surface 102b of the 3D glass layer 102. At last, blade cutting, laser cutting or water jet cutting way as selectively is used to remove the remaining decorative layer. Being concise, the embodiment can tightly adhere the decorating layer 204 to the back surface 102b of the 3D glass layer 102 by the transfer molding process. In an embodiment, the transfer molding process can be considered as an OMD technology.

After then, the step S240 is performed, in which a light emitting layer is formed under the decorating layer 204 (or the base layer 204a), so that the decorating layer 204 is located between the 3D glass layer 102 and the light emitting layer 106. Since the light emitting layer 106 of the second embodiment is similar to the light emitting layer 106 of the first embodiment, in which the type and the forming method have been described in previous descriptions, and are not repeated in descriptions. In addition, the 3D glass structure 200 can further include a second adhesive layer 108 (as shown in FIG. 4) disposed under the light emitting layer 106, so that the 3D glass structure 200 is adhered to the workpiece 300 (as shown in FIG. 4) through the second adhesive layer 108.

Remarkably, the decorating layer 204 adhered to the back surface 102b of the 3D glass layer 102 not only has the decorating effect but also has the explosion-proof feature. The meaning of explosion-proof is that it is not easily damaged or broken after dropping, external impact or external compression forces occurs on the 3D glass structure 200 of the invention. Therefore, comparing with the conventional 3D glass structure, the 3D glass structure 200 of the invention or the decorated molding article having the 3D glass structure 200 can have better protection capability.

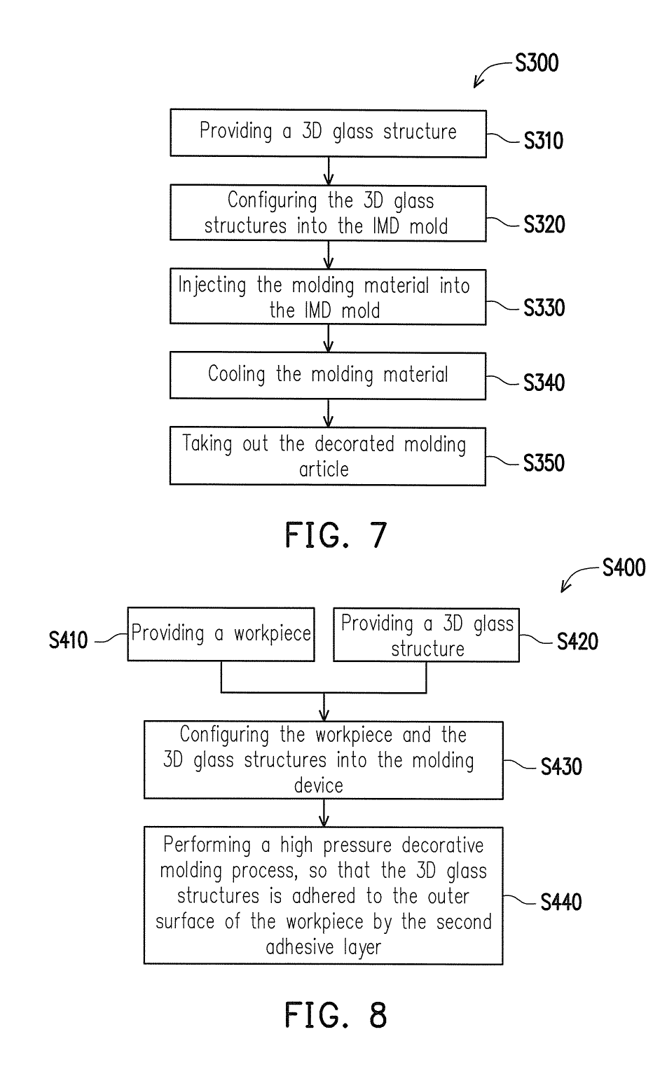

FIG. 3 is a schematic drawing, illustrating a cross-sectional structure of the decorated molding article, according to a third embodiment of the invention. FIG. 4 is a schematic drawing, illustrating a cross-sectional structure of the decorated molding article, according to a fourth embodiment of the invention. FIG. 7 is a flow-chat drawing, illustrating a fabricating flow of the decorated molding article, according to a fifth embodiment of the invention. FIG. 8 is a flow-chat drawing, illustrating a fabricating flow of the decorated molding article, according to a sixth embodiment of the invention.

Referring to FIG. 3 to FIG. 4, FIG. 3 shows that the 3D glass structure 100 is disposed on the workpiece 300, to form the decorated molding article 10 in the third embodiment. FIG. 4 shows that the 3D glass structure 200 is disposed on the workpiece 300, to form the decorated molding article 20 in the fourth embodiment. Both the foregoing decorated molding articles 10 and 20 can be fabricated by the fabrication method in FIG. 7, such as an IMD technology, or fabricated by the fabrication method in FIG. 8, such as an OMD technology.

Referring to FIG. 7, the fabrication process S300 for the decorated molding article of the fifth embodiment is following. At first, the step S310 is performed to provide a 3D glass structure. The 3D glass structure in an example can be any one of the 3D glass structures 100, 200 as shown in FIG. 1 and FIG. 2, and is simply referred as the 3D glass structures 100, 200, hereinafter. The composition of the 3D glass structures 100, 200 has been described in foregoing descriptions, and is not repeated in descriptions.

Then, the step S320 is performed to configure the 3D glass structures 100, 200 into the IMD mold. In detail, the IMD mold includes a hollow molding cavity. The molding cavity has a surface. After then, the 3D glass structures 100, 200 adheres on the surface of the molding cavity, so the 3D glass structures 100, 200 at least covers a portion of the surface of the molding cavity.

Then, the step S330 is performed to inject the molding material into molding cavity of the IMD mold and let the molding material combine with the 3D glass structures 100, 200. In an embodiment, the molding material can be a plastic material as an example.

Then, the step S340 is performed to cool the molding material and to form the workpiece 300. Depending on the application of the decorated molding article of the invention, the workpiece 300 can be a housing or an assembly element of electronic apparatus, a housing or an assembly element of vehicle or a combination thereof. However, the invention is not limited to the shape and structure of the workpiece 300, any workpiece 300 of which the shape and structure can be accomplished by the IMD technology is falling into the scope of the invention.

Then, the step S350 is performed to take the decorated molding article 10, 20 out from the IMD mold. At this moment, the decorated molding article 10, 20, as shown in FIG. 3 to FIG. 4, includes the 3D glass structure 100, 200 and the workpiece 300. The 3D glass structure 100, 200 is respectively adhered to a portion of the outer surface 300a of the work piece 300 through the second adhesive layer 108, so that the second adhesive layer 108 is configured between the light emitting layer 106 and the workpiece 300. The portion of the outer surface 300a covered by the 3D glass structure 100, 200 in an example can be a region to be decorated by the decorated molding article 10, 20 as formed.

On the other hand, the decorated molding article 10, 20 can be fabricated by the OMD technology. Referring to FIG. 8, the fabrication process S400 for the decorated molding article of the sixth embodiment is following. At first, the step S410 is performed to provide a 3D glass structure. Depending on the application of the decorated molding article of the invention, the workpiece 300 can be a housing or an assembly element of electronic apparatus, a housing or an assembly element of vehicle or a combination thereof. Taking an example, the workpiece 300 a mobile phone, digital camera, personal digital assistant (PDA), laptop computer, desktop computer, touch panel, TV, globe position system (GPS) apparatus, car monitor, navigation, display, digital photo frame, DVD player, automotive interior decoration board (for example, handles, trim, front door of touch control, etc.), automotive exterior decoration board (for example, exterior handles, back door trim, etc.), car dashboard, car logo, intelligent key (I-key), engine start button, clocks, radios, toys, watches and other electronic products require power used. In an embodiment, material of the outer surface 300a of the workpiece 300 can be plastic, metal, carbon fiber, glass or other various hosing material already being molded. In particular example, the workpiece has been fabricated to have needed features by properly pre-processing. As an example, when material of the workpiece is plastic, the plastic workpiece can be obtained by an injection molding process with the injection molding machine, such as a plastic housing. Further in an example, when the material of the workpiece is metal, the surface processing can be firstly performed on the metal to obtain the metallic workpiece, such as metallic housing.

In an embodiment, the decorated molding article can have applications in I-key or engine start button. In detail, the I-key is a keyless system, which allows a car owner to open the door and then drive the car in the whole driving action without using a key. When the car owner has the I-key and enters an effective detection range of the car, the car would automatically detect the I-key and perform the identification. Once the identification completes, the door or the trunk can be easily opened through the door handle or the trunk handle. When the owner enters the car, the car would automatically detect the location of the I-key to determine whether or not the I-key is inside the car. If the I-key is inside the car, the system would automatically start the engine when the owner presses the engine start button. In an embodiment, the foregoing engine start button can be activated by touch-control, fingerprint recognition or the combination thereof. Thus, the invention can apply the 3D glass structure adheres onto an outer appearance of the I-key or the engine start button, so that the decorated molding article as formed, including 3D glass structure with the I-key or 3D glass structure with the engine start button, not only has the effect of emitting light and decoration but also has explosion-proof feature.

Then the step S420 is performed to provide 3D glass structure. The 3D glass structure in an example can be any one of the 3D glass structures 100, 200 as shown in FIG. 1 to FIG. 2 and is indicated by 3D glass structure 100, 200 hereinafter. The composition of the 3D glass structures 100, 200 has been described in foregoing descriptions, and is not repeated in descriptions.

Then, the step S430 is performed to configure the 3D glass structures 100, 200 into the molding device. Remarkably here, before the step S430, the molding device as accordingly needed by the final product can selectively designed and the molding device is then prepared.

Then, the step S440 is performed to perform a high pressure decorated molding process, so that the 3D glass structures 100, 200 is adhered to the outer surface 300a of the workpiece 300 by the second adhesive layer 108. Thereby, the second adhesive layer 108 is configured between the light emitting layer 108 and the workpiece 300. In detail, the high pressure decorated molding process in an example can firstly perform a heating and softening process on the 3D glass structure 100, 200. In an embodiment, the temperature of the heating and softening process can be between 80° C. and 150° C.; and the time duration of the heating and softening process can be between 30 seconds and 180 seconds. Then, the 3D glass structure 100, 200 contacts with the workpiece 300 and a high pressing step is performed. Then, the 3D glass structure 100, 200 and the workpiece 300 are again performed with high pressure vacuum molding process, so the 3D glass structure 100, 200 is transferred to the workpiece 300. At last, die cutting, laser cutting or water jet cutting way as selectively is used to remove the remaining decorative layer. Being concise, the embodiment can tightly adhere the 3D glass structure 100, 200 to the outer surface 300a of the workpiece 300 by OMD technology.

As to the foregoing descriptions, the invention uses IMD technology or the OMD technology to decorate the 3D glass structure onto the workpiece, so that the appearance of the workpiece can have streamlined appearance and 3D dimensional texture, and further provide a better 3D tactile texture to the user. In addition, comparing with the conventional decorating piece, the 3D glass structure of the invention further has the capabilities of expanding effect, no frame design, lighting design and pattern highlight. As a result, the 3D glass structure of the invention can provide the user with a decorating quality different from the conventional decorating piece. Further in the invention, the decorating layer is adhered to the back surface of the 3D glass layer, so to form the 3D glass structure. As a result, the 3D glass structure not only has the decorating effect but also has explosion-proof features.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional (3D) glass structure, for decorating a workpiece, the 3D glass structure comprising:
a 3D glass layer, having a front surface and a back surface opposite to each other;
a light emitting layer, disposed on the back surface of the 3D glass layer; and
a decorating layer, disposed between the 3D glass layer and the light emitting layer.

2. The 3D glass structure of claim 1, wherein the front surface of the 3D glass layer comprises a matte finish surface, a mirror surface, an uneven surface, or a combination thereof.

3. The 3D glass structure of claim 1, wherein the 3D glass layer comprises a curving-surface glass, a flat-surface glass, or a combination thereof.

4. The 3D glass structure of claim 1, wherein the decorating layer comprises a single layer structure or a multi-layer structure.

5. The 3D glass structure of claim 1, wherein the decorating layer comprises:
a base layer;
a pattern layer, disposed on the base layer; and
a hard coating layer, disposed between the base layer and the pattern layer.

6. The 3D glass structure of claim 5, wherein the decorating layer further comprises a first adhesive layer disposed on the pattern layer, so that the decorating layer is adhered to the back surface of the 3D glass layer by the first adhesive layer.

7. The 3D glass structure of claim 5, wherein the hard coating layer has a first surface and a second surface opposite to each other, the first surface is an uneven surface and the second surface is a flat surface.

8. The 3D glass structure of claim 7, wherein the hard coating layer contacts with the pattern layer via the first surface, and contacts with the base layer via the second surface.

9. The 3D glass structure of claim 1, wherein the light emitting layer comprises a backlight module of light emitting diode, a backlight module of conductive polymer, or a combination thereof.

10. A decorated molding article, comprising:
a workpiece, having an outer surface; and
the 3D glass structure as recited in claim 1, disposed on the outer surface of the workpiece, wherein the 3D glass structure is adhered to the workpiece via a second adhesive layer.

11. The decorated molding article of claim 10, wherein a material of the outer surface of the workpiece comprises plastic, metal, carbon fiber, glass, or a combination thereof.

12. The decorated molding article of claim 10, wherein the workpiece comprises a housing or an assembly part of an electronic apparatus, a housing or an assembly part of vehicle or a combination thereof, and the housing or the assembly part of vehicle comprises interior decoration of car, exterior decoration of car, car logo, car dashboard, intelligent key (I-key), engine start button, or a combination thereof.

13. A fabrication method for a decorated molding article, comprising:
providing the 3D glass structure as recited in claim 1; and
performing an in-mold decoration (IMD) process or an out mold decoration (OMD) process on the 3D glass structure, so that the 3D glass structure is adhered to an outer surface of a workpiece via a second adhesive layer.

14. The fabrication method for the decorated molding article of claim 13, wherein the IMD process performed on the 3D glass structure comprises:
disposing the 3D glass structure in an IMD mold having a molding cavity, wherein the 3D glass structure covers at least a portion of a surface of the molding cavity;
injecting the molding material into the IMD mold, so that the molding material and the 3D glass structure are combined to each other;
cooling the molding material; and
taking the decorated molding article out from the IMD mold.

15. The fabrication method for the decorated molding article of claim 13, wherein processing 3D glass structure performed by the OMD process comprises:
providing a workpiece;
disposing the workpiece and the 3D glass structure in a mold;
performing a high pressure decorative molding process, so as to adhere the 3D glass structure onto the outer surface of the workpiece via a second adhesive layer.

16. The fabrication method for the decorated molding article of claim 15, wherein the high pressure decorative molding process comprises:
performing a heating and softening process on the 3D glass structure;
contacting the 3D glass structure with the workpiece and performing a pressing process; and
performing a high pressure vacuum molding process on the 3D glass structure and the workpiece, so that the 3D glass structure adheres onto the outer surface of the workpiece.

17. The fabrication method for the decorated molding article of claim 13, wherein a process for forming the 3D glass structure comprises:
providing a 3D glass layer, the 3D glass layer having a front surface and back surface opposite to each other;
forming a light emitting layer on the back surface of the 3D glass layer; and
forming a decorating layer between the 3D glass layer and the light emitting layer.

18. The fabrication method for the decorated molding article of claim 17, wherein a process to form the decorating layer between the 3D glass layer and the light emitting layer comprises:
providing a base layer;
forming a pattern layer on the base layer;
forming a hard coating layer between the base layer and the pattern layer; and
forming a first adhesive layer on the pattern layer.

19. The fabrication method for the decorated molding article of claim 18, wherein a process to form the decorating layer between the 3D glass layer and the light emitting layer comprises performing a transfer molding process, the transfer molding process comprises:
performing a heating process on the decorating layer;
contacting the first adhesive layer of the decorating layer with the back surface of the 3D glass layer and performing a pressing process, so that the decorating layer is adhered to the back surface of the 3D glass layer via the first adhesive layer.

20. The fabrication method for the decorated molding article of claim 17, wherein a process for forming the decorating layer comprises directly forming the decorating layer on the back surface of the 3D glass layer by using printing, spray coating, electrical plating, vapor deposition, sputtering deposition, or a combination thereof.
